(19) United States
(12) Patent Application Publication
(10) Pub. No.: US 2025/0087731 A1
(43) Pub. Date: Mar. 13, 2025

(54) SYSTEMS AND METHODS FOR GAS LEVEL DETECTION

(71) Applicant: Volvo Truck Corporation, GÖTEBORG (SE)

(72) Inventors: Rikard HULTHÉN, Stora Höga (SE); André Luís KLOSTERMANN, Torslanda (SE)

(21) Appl. No.: 18/730,542

(22) PCT Filed: Feb. 9, 2022
(86) PCT No.: PCT/IB2022/051138

§ 371 Date: Jul. 19, 2024

(51) Int. Cl. H01M 8/0438; H01M 8/04029; H01M 8/0432; H01M 8/04664

(52) U.S. Cl. CPC H01M 8/04417; H01M 8/04029; H01M 8/04358; H01M 8/04686; H01M 2250/20

(57) ABSTRACT

A method of detecting a level of gas in a closed coolant system by a gas level monitoring system includes detecting a level of gas pressure applied to the closed coolant system, detecting a change of fluid pressure in the closed coolant system in response to the applied gas pressure, and determining the level of gas in the closed coolant system based on the change of fluid pressure in the closed coolant system in response to the applied gas pressure. Related coolant systems and gas level monitoring systems are disclosed.

### FIELD

The present disclosure relates to coolant systems, and in particular to detection of coolant levels in coolant systems for fuel cell.

### BACKGROUND

Fuel cell systems are increasingly being used to power vehicles, including construction vehicles, trucks, and other large size vehicles or heavy equipment due in part to the reduced carbon emissions generated by such systems. However, fuel cell systems may generate significant heat during operation due to the exothermic nature of the fuel cell reaction. As such, fuel cells require increased cooling capacity, which is typically provided by a closed loop liquid coolant system that dissipates heat generated in the fuel cell to the atmosphere via one or more heat exchangers. In a construction vehicle or truck, the heat exchangers may be installed behind and/or above the passenger cabin where they may be inconvenient to service.

The efficiency of the coolant system may be impaired if air and/or other gases become trapped within the coolant fluid lines. Thus, it is important to be able to check the level of coolant in the system. Moreover, when a fuel cell system is serviced, it is often desirable to drain the coolant liquid from the coolant system and refill the coolant system with a predetermined amount of coolant liquid so that little to no gas is left in the coolant system.

Determining the level of coolant in the coolant system of a vehicle typically involves visual inspection of the coolant level through a coolant expansion tank that is typically mounted on top of the cooling system, within the engine compartment or in the front of the cab. However, when cooling system components are mounted behind or above the cab of a vehicle, visual inspection of coolant levels may be difficult. Instead of relying on visual inspection, a coolant level sensor may be provided within the coolant system. However, the effectiveness of such a sensor may be impaired by the presence of foam and/or bubbles in the coolant liquid. For such a sensor to provide a reliable reading, it may be necessary to wait for the coolant to settle first, which may result in undesirable delays in servicing or operating the vehicle.

### SUMMARY

A method of detecting a level of gas in a closed coolant system by a gas level monitoring system includes detecting a level of gas pressure applied to the closed coolant system, detecting a change of fluid pressure in the closed coolant system in response to the applied gas pressure, and determining the level of gas in the closed coolant system based on the change of fluid pressure in the closed coolant system in response to the applied gas pressure.

A closed coolant system according to some embodiments includes a coolant line, a fluid pressure sensor coupled to the coolant line that detects a level of fluid pressure in the coolant line, a pressure equalizer including an input port that receives applied gas pressure from a pressure source and an output port that applies pressure to the coolant line in response to the applied gas pressure, and a gas pressure sensor that detects a level of the applied gas pressure. The system further includes a gas level monitoring system that detects a change of fluid pressure in the coolant line in response to the applied gas pressure and determines a level of gas in the coolant line based on the change of fluid pressure in the coolant line in response to the applied gas pressure. The pressure source may include a turbine or compressor coupled to the pressure equalizer.

Some embodiments provide a gas level monitoring system for monitoring a closed coolant system including a coolant line and a pressure equalizer including an input port that receives applied gas pressure from a pressure source and an output port that applies pressure to the coolant line in response to the applied gas pressure, a fluid pressure sensor coupled to the coolant line that detects a level of fluid pressure in the coolant line, and a gas pressure sensor that detects a level of the applied gas pressure. The gas level monitoring system includes a sensor interface for receiving gas pressure measurement results from the gas pressure sensor and fluid pressure measurement results from the fluid pressure sensor, and a processor coupled to the sensor interface that receives the gas pressure measurement results and the fluid pressure measurement results, detects a change of fluid pressure in the coolant line in response to the applied gas pressure based on the gas pressure measurement results and the fluid pressure measurement results, and determines a level of gas in the coolant line based on the change of fluid pressure in the coolant line in response to the applied gas pressure.

### ASPECTS

According to an aspect, a method of detecting a level of gas in a closed coolant system by a gas level monitoring system includes detecting a level of gas pressure applied to the closed coolant system, detecting a change of fluid pressure in the closed coolant system in response to the applied gas pressure, and determining the level of gas in the closed coolant system based on the change of fluid pressure in the closed coolant system in response to the applied gas pressure.

According to a further aspect, detecting the change of fluid pressure in the closed coolant system includes detecting a rate of change of fluid pressure in the closed coolant system.

According to a further aspect, determining the level of gas in the closed coolant system includes comparing the rate of change of fluid pressure in the closed coolant system to a threshold rate of change.

According to a further aspect, the method may further include determining that there may be excess gas in the closed coolant system when the rate of change of fluid pressure in the closed coolant system may be less than the threshold rate of change. The threshold rate of change may be based on a temperature of the fluid in the closed coolant system.

According to a further aspect, the method may further include calibrating the closed coolant system by measuring rates of change of fluid pressure in response to applied gas pressure for different temperatures of fluid and different levels of gas in the closed coolant system.

According to a further aspect, the method may further include adjusting a calibration of the closed coolant system based on aging of components in the closed coolant system.

According to a further aspect, calibrating the closed coolant system includes measuring rates of change of fluid pressure in response to applied gas pressure for different temperatures of fluid in the closed coolant system during operation of the closed coolant system.

According to a further aspect, applying the gas pressure to the closed coolant system includes applying pressure to a pressure equalizer fluidly coupled to the closed coolant system.

According to a further aspect, the pressure equalizer may include a tank including a fluid chamber, a gas chamber and a movable surface between the fluid chamber and the gas chamber that transmits pressure between the fluid chamber and the gas chamber. The movable surface includes a flexible membrane or a piston.

According to a further aspect, the closed coolant system may be a coolant system for a fuel cell, and applying the gas pressure to the closed coolant system may include generating gas pressure in the fuel cell and applying the generated gas pressure to the closed coolant system.

According to a further aspect, a closed coolant system includes a coolant line, a fluid pressure sensor coupled to the coolant line that detects a level of fluid pressure in the coolant line, a pressure equalizer including an input port that receives applied gas pressure from a pressure source and an output port that applies pressure to the coolant line in response to the applied gas pressure, and a gas pressure sensor that detects a level of the applied gas pressure. The system further includes a gas level monitoring system that detects a change of fluid pressure in the coolant line in response to the applied gas pressure and determines a level of gas in the coolant line based on the change of fluid pressure in the coolant line in response to the applied gas pressure. The pressure source may include a turbine or compressor coupled to the pressure equalizer.

According to a further aspect, a gas level monitoring system for monitoring a closed coolant system including a coolant line and a pressure equalizer including an input port that receives applied gas pressure from a pressure source and an output port that applies pressure to the coolant line in response to the applied gas pressure, a fluid pressure sensor coupled to the coolant line that detects a level of fluid pressure in the coolant line, and a gas pressure sensor that detects a level of the applied gas pressure. The gas level monitoring system includes a sensor interface for receiving gas pressure measurement results from the gas pressure sensor and fluid pressure measurement results from the fluid pressure sensor, and a processor coupled to the sensor interface that receives the gas pressure measurement results and the fluid pressure measurement results, detects a change of fluid pressure in the coolant line in response to the applied gas pressure based on the gas pressure measurement results and the fluid pressure measurement results, and determines a level of gas in the coolant line based on the change of fluid pressure in the coolant line in response to the applied gas pressure.

### BRIEF DESCRIPTION OF THE DRAWINGS

FIG. 1 is a block diagram that illustrates a closed cooling system for a fuel cell and a system for detecting a coolant level in the closed cooling system according to some embodiments.

FIG. 2 illustrates a principle of operation of a fuel cell system.

FIG. 3 illustrates a structure of a fuel cell system including coolant channels.

FIG. 4 illustrates a pressure equalizer that may be used in a closed cooling system for a fuel cell according to some embodiments.

FIG. 5 illustrates a coolant level monitoring system according to some embodiments.

FIG. 6 is an example graph showing coolant pressure in a closed coolant system for a fuel cell system as a function of power generated by the fuel cell.

FIG. 7 is a graph illustrating fluid pressure in a closed coolant system for a fuel cell system as a function of time in response to applied gas pressure.

FIG. 8 is a flowchart that illustrates operations of systems/methods according to some embodiments.

### DETAILED DESCRIPTION

Embodiments described herein provide systems and/or methods that can detect a level of coolant in a closed coolant system (or alternately, detect a level of gas in the closed coolant system). In particular, embodiments descried herein are based on an observation that gas and liquids, such as liquid coolant, have different compressibility characteristics. While gas is highly compressible, liquids are virtually non-compressible.

Fuel cell power systems, such as fuel cell power systems for vehicles, rely on cooling systems to manage heat generated in the fuel cell. A fuel cell power system may include a mechanism, such as a pressure equalizer, to control coolant circuit pressure. In particular, gas pressure generated by a compressor in the fuel cell power system may be applied to a pressure equalizer, which applies a corresponding level of pressure to the liquid coolant. It is possible to compare the response of the coolant pressure to the applied gas pressure and determine, based on the response, how much gas is present in the coolant system. That is, when pressure is applied to the coolant liquid, then due to the relative compressibility of air, the more gas is in the coolant system, the slower the response will be to the applied pressure. Conversely, the less gas there is in the coolant system, the quicker the response will be.

By measuring the response of coolant fluid pressure to the applied gas pressure, and in particular by measuring the rate of change of the fluid pressure to the applied gas pressure, an estimate can be generated of the amount of gas that is present in the coolant system and/or of the level of coolant liquid in the coolant system. A system/method according to some embodiments can also be used to detect problems in the system, such as coolant leakage.

In some embodiments, the system may be calibrated to account for expansion of components such as pipes and hoses when pressure is applied. The calibration system may take into account heating and/or aging of the components. This may be accomplished using a learning function that detects and accounts for changes over time while the system is operating.

Some embodiments may not require extra hardware components beyond the existing components of a fuel cell system and fuel cell cooling system.

This concept may be combined with a physical level sensor in some embodiments. In such case, the sensor may be mounted at or near the highest point of the system, such as on top of an upper heat exchanger.

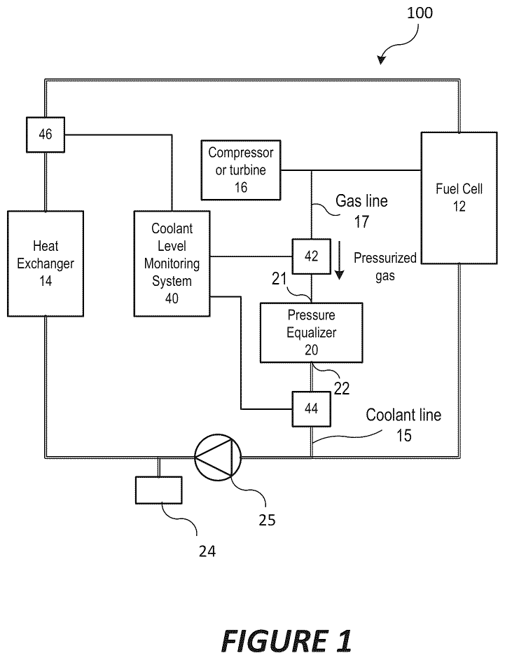

FIG. 1 is a block diagram that illustrates a closed cooling system 100 including a coolant fluid line 15 for a fuel cell 12 and a system 40 for detecting a coolant level in the closed cooling system 100. according to some embodiments. As shown in FIG. 1, a coolant fluid line 15 carries coolant fluid that flows through a fuel cell 12 to cool the fuel cell 12 during operation. Heat extracted from the fuel cell 12 is dissipated from the coolant fluid to the environment in one or more heat exchangers 14. The coolant fluid is pumped through the coolant system 100 by a pump 25. Coolant is added to the coolant fluid line 15 through a port 24.

A fluid pressure sensor 44 is coupled to the coolant fluid line 15 and detects a level of fluid pressure in the coolant fluid line 15. As explained below, the level of fluid pressure in the coolant fluid line 15 may need to be adjusted to maintain a desired level of fluid pressure within the fuel cell 12. The system 100 includes a pressure equalizer 20 having an input port 21 that receives applied gas pressure via a gas line 17 from a pressure source, such as a compressor or turbine 16, coupled to the fuel cell 12 and an output port 22 that applies pressure to the coolant fluid line 15 in response to the applied gas pressure. When the compressor or turbine 16 is a compressor, the gas pressure is taken from the high pressure side of the compressor 16. Conversely, when compressor or turbine 16 is a turbine, the gas pressure is taken from the low pressure side of the turbine 16.

A gas pressure sensor 42 detects a level of the applied gas pressure. The speed of the compressor or turbine 16, which determines the pressure applied to the coolant fluid, is adjusted based on the desired fluid pressure within the fuel cell 12. A temperature sensor 46 coupled to the coolant fluid line 15 measures a temperature of the coolant fluid in the coolant fluid line 15. The gas pressure sensor 42, fluid pressure sensor 44 and temperature sensor 46 are coupled to the coolant level monitoring system 40 and provide measurements of gas pressure, coolant fluid pressure and coolant fluid temperature, respectively, to the coolant level monitoring system 40.

A coolant level monitoring system 40 detects a change of fluid pressure in the coolant fluid line 15 in response to the applied gas pressure, and determines a level of coolant fluid in the coolant fluid line 15 based on the change of fluid pressure in the coolant fluid line 15 in response to the applied gas pressure. In particular, when the level of coolant fluid in the coolant fluid line 15 is low, the fluid pressure in the coolant system will respond more slowly to applied gas pressure. In response to determining that the level of coolant fluid in the coolant system is low, the coolant level monitoring system may raise an alarm to alert an operator to add coolant fluid to the system.

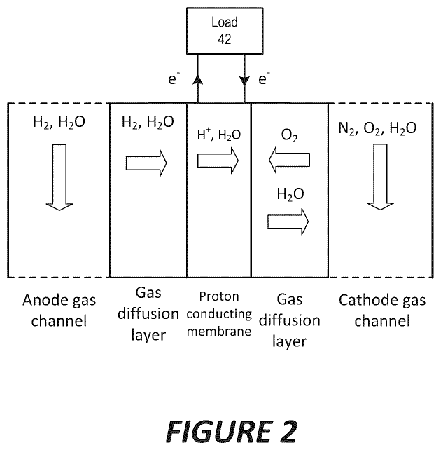

FIG. 2 illustrates a principle of operation of a fuel cell system. In particular, FIG. 2 schematically illustrates the operation of a proton-exchange membrane fuel cell (PEMFC). In a PEMFC, a proton-conducting polymer membrane contains an electrolyte solution is provided between an anode gas channel and a cathode gas channel. The proton conducting membrane is separated from the gas channels by gas diffusion layers. On the anode side, hydrogen diffuses to an anode catalyst in the gas diffusion layer where it dissociates into protons and electrons. The protons are conducted through the membrane to the cathode, but the electrons are forced to travel in an external circuit or load 42 because the proton conducting membrane is electrically insulating. On the cathode side, oxygen molecules react with the electrons (which have traveled through the external circuit) and protons to form water.

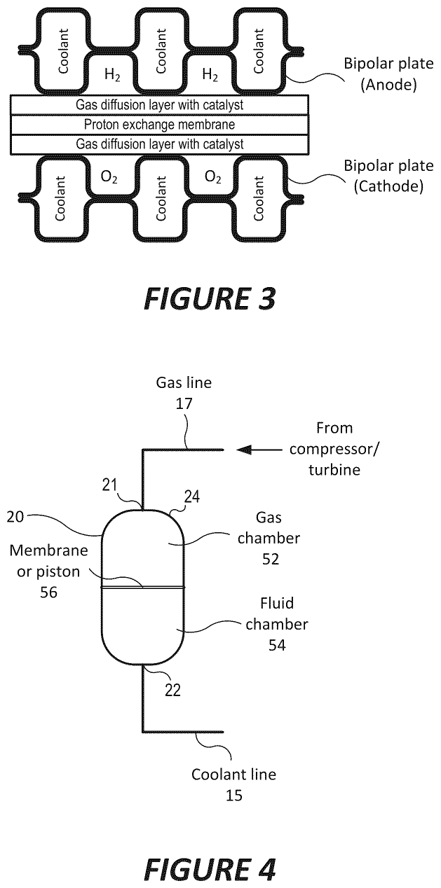

FIG. 3 illustrates a structure of a fuel cell system including coolant channels. As can be seen in FIG. 3, coolant channels are provided adjacent to the gas channels. Because the reactions described above are exothermic, the coolant is required to maintain the temperature of the fuel cell. However, due to the structure of the bipolar plates that separate the coolant channels from the gas channels, it is important for the pressure within the coolant channels and the pressure within the gas channels to be balanced in order to prevent the bipolar plates from rupturing or otherwise becoming damaged. To balance the pressures, the pressure of the liquid coolant may be adjusted by changing the speed at which the compressor or turbine 16 shown in FIG. 1 spins. The faster the compressor spins, the higher the pressure in the coolant channel, and vice-versa.

FIG. 4 illustrates a pressure equalizer 20 that may be used in a closed cooling system 100 for a fuel cell 12 according to some embodiments. The pressure equalizer 20 includes a tank 24 having a rigid outer shell that defines a gas chamber 52 and a fluid chamber 54 therein that are separated by a flexible membrane or movable piston 56. The tank includes an input port 21 coupled to the gas line 17 and an output port 22 coupled to the fluid line 15. Gas from the compressor or turbine 16 enters the gas chamber 52 via the gas line 17 and pressurizes the gas chamber 52. The flexible membrane or piston 56 transmits the gas pressure applied by the compressor 16 to fluid in the fluid chamber 54, which transfers the applied pressure to the coolant fluid line 15. Thus, the compressor or turbine 16 controls the pressure within the fluid line 15 in response to demand by the fuel cell 12.

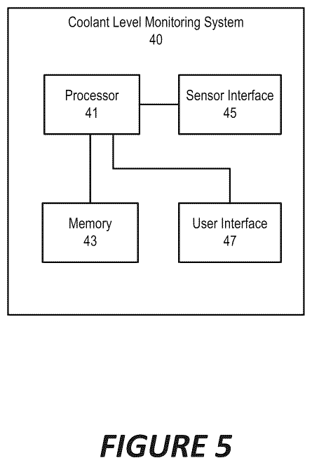

FIG. 5 illustrates a coolant level monitoring system 40 according to some embodiments in more detail. As shown in FIG. 5, the coolant level monitoring system 40 includes a sensor interface 45 for receiving gas pressure measurement results from the gas pressure sensor 42 and fluid pressure measurement results from the fluid pressure sensor 44.

The coolant level monitoring system 40 includes a processor 41 coupled to the sensor interface that receives the gas pressure measurement results and the fluid pressure measurement results and detects a change of fluid pressure in the coolant fluid line 15 in response to the applied gas pressure based on the gas pressure measurement results and the fluid pressure measurement results. The coolant level monitoring system 40 determines a level of coolant fluid in the coolant fluid line 15 based on the change of fluid pressure in the coolant fluid line in response to the applied gas pressure.

The coolant level monitoring system 40 also includes a user interface 47 that can output the results of the coolant level monitoring and, for example, generate an alarm if the coolant level is below a desired level.

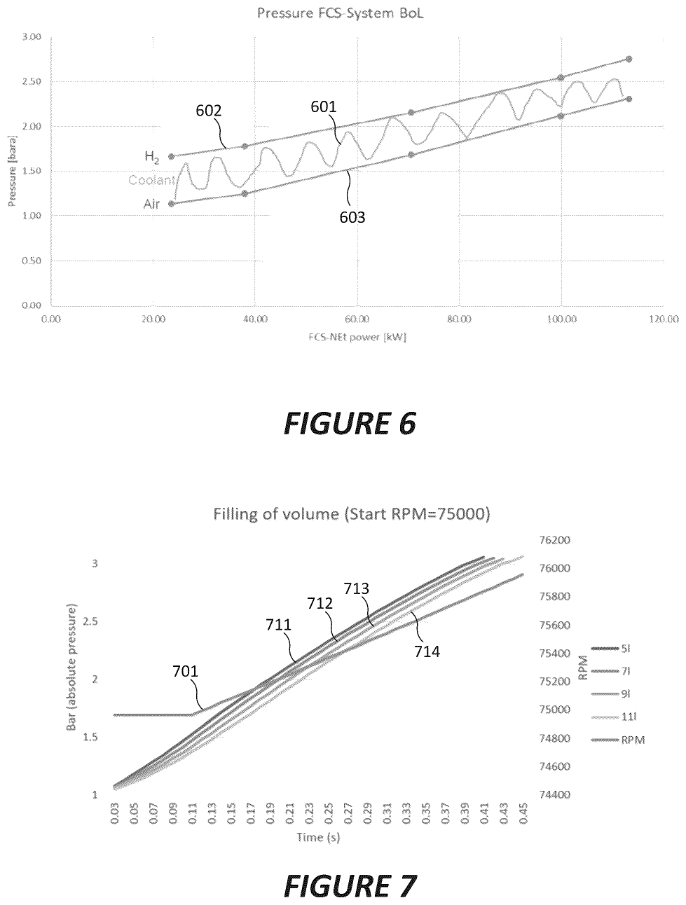

FIG. 6 is an example graph showing coolant pressure in a closed coolant system for a fuel cell system as a function of power generated by the fuel cell. In FIG. 6, the coolant fluid pressure is indicated by curve 601, while H2 pressure is indicated by curve 602 and gas pressure is indicated by curve 603. As shown in FIG. 6, it is desired to keep the coolant fluid pressure between the H2 pressure and the gas pressure over the operational power range of the fuel cell.

FIG. 7 is a graph illustrating fluid pressure in a closed coolant system for a fuel cell system as a function of time in response to applied gas pressure for different levels of gas in the coolant fluid line. In particular, curve 701 represents the speed in revolutions per minute (RPM) of the compressor or turbine 16. Curves 711, 712, 713 and 714 represent the pressure in the coolant fluid line 15 as a function of time in response to the change in RPM of the compressor for gas levels in the coolant fluid line 15 of 5 liters, 7 liters, 9 liters and 11 liters, respectively. As can be seen in FIG. 7, the pressure in the coolant fluid line responds differently depending on the level of gas in the coolant fluid line 15. In particular, the sloped of the curve is greater, indicating a quicker response, when there is less gas in the coolant fluid line 15.

When pressure is applied to the gas line 17 by the compressor or turbine 16, the coolant level monitoring system 40 detects the response of the fluid pressure in the coolant fluid line 15 and estimates how much gas is the coolant fluid line 15 based on the response.

Because the response of the coolant fluid pressure to changes in gas pressure generated by the compressor or turbine 16 can change over time and in response to heating of the components, such as pipes, tubes and fittings, the coolant level monitoring system 40 may adjust the model used to determine coolant fluid level over time using a learning function.

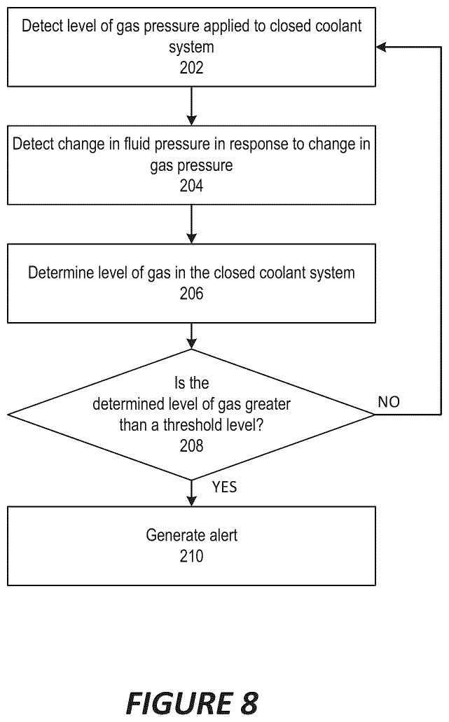

FIG. 8 is a flowchart that illustrates operations of systems/methods according to some embodiments. Referring to FIGS. 1 and 8, a method of detecting a level of coolant in a closed coolant system 100 by a coolant level monitoring system 40 includes detecting (block 202) a level of gas pressure applied to the closed coolant system, detecting (block 204) a change of fluid pressure in the closed coolant system in response to the applied gas pressure, and determining (block 206) a level of gas in the closed coolant system based on the change of fluid pressure in the closed coolant system in response to the applied gas pressure.

Applying the gas pressure to the closed coolant system may be performed by applying pressure to a pressure equalizer 20 fluidly coupled to the closed coolant system 100. As shown in FIG. 4, the pressure equalizer 20 may include a tank 24 including a fluid chamber 54, a gas chamber 62 and a flexible membrane 56 between the fluid chamber 54 and the gas chamber 56.

The closed coolant system 100 may be a coolant system for a fuel cell 12, and applying the gas pressure to the closed coolant system 100 may include generating gas pressure in the fuel cell 12 and applying the generated gas pressure to the closed coolant system 100.

In some embodiments, detecting the change of fluid pressure in the closed coolant system 100 may include detecting a rate of change of fluid pressure in the closed coolant system 100.

Determining the level of gas in the closed coolant system 100 may include comparing the rate of change of fluid pressure in the closed coolant system 100 to a threshold rate of change. The method may further include determining (block 208) that there is excess gas in the closed coolant system 100 when the rate of change of fluid pressure in the closed coolant system is less than the threshold rate of change, which indicates that the level of gas in the coolant system is greater than a threshold level, and if so, generating an alert (block 210). The threshold rate of change may be based on a temperature of the fluid in the closed coolant system 100.

The method may further include calibrating the closed coolant system 100 by measuring rates of change of fluid pressure in response to applied gas pressure for different temperatures of fluid and different levels of gas in the closed coolant system 100. In some embodiments, the method may further include adjusting a calibration of the closed coolant system 100 based on aging of components in the closed coolant system. Calibrating the closed coolant system may include measuring rates of change of fluid pressure in response to applied gas pressure for different temperatures of fluid in the closed coolant system 100 during operation of the closed coolant system 100.

When an element is referred to as being “connected”, “coupled”, “responsive”, “mounted”, or variants thereof to another element, it can be directly connected, coupled, responsive, or mounted to the other element or intervening elements may be present. In contrast, when an element is referred to as being “directly connected”, “directly coupled”, “directly responsive”, “directly mounted” or variants thereof to another element, there are no intervening elements present. Like numbers refer to like elements throughout. As used herein, the singular forms “a”, “an” and “the” are intended to include the plural forms as well, unless the context clearly indicates otherwise. Well-known functions or constructions may not be described in detail for brevity and/or clarity. The term “and/or” and its abbreviation “/” include any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but do not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Persons skilled in the art will recognize that certain elements of the above-described embodiments may variously be combined or eliminated to create further embodiments, and such further embodiments fall within the scope and teachings of inventive concepts. It will also be apparent to those of ordinary skill in the art that the above-described embodiments may be combined in whole or in part to create additional embodiments within the scope and teachings of inventive concepts. Thus, although specific embodiments of, and examples for, inventive concepts are described herein for illustrative purposes, various equivalent modifications are possible within the scope of inventive concepts, as those skilled in the relevant art will recognize. Accordingly, the scope of inventive concepts is determined from the appended claims and equivalents thereof.

1. A method of detecting a level of gas in a closed coolant system by a gas level monitoring system, the method comprising:
detecting a level of gas pressure applied to the closed coolant system;
detecting a change of fluid pressure in the closed coolant system in response to the applied gas pressure; and
determining the level of gas in the closed coolant system based on the change of fluid pressure in the closed coolant system in response to the applied gas pressure.

2. The method of claim 1, wherein detecting the change of fluid pressure in the closed coolant system comprises detecting a rate of change of fluid pressure in the closed coolant system.

3. The method of claim 2, wherein determining the level of gas in the closed coolant system comprises comparing the rate of change of fluid pressure in the closed coolant system to a threshold rate of change.

4. The method of claim 3, further comprising determining that there is excess gas in the closed coolant system when the rate of change of fluid pressure in the closed coolant system is less than the threshold rate of change.

5. The method of claim 3, wherein the threshold rate of change is based on a temperature of the fluid in the closed coolant system.

6. The method of claim 3, further comprising calibrating the closed coolant system by measuring rates of change of fluid pressure in response to applied gas pressure for different temperatures of fluid and different levels of gas in the closed coolant system.

7. The method of claim 6, further comprising adjusting a calibration of the closed coolant system based on aging of components in the closed coolant system.

8. The method of claim 6, wherein calibrating the closed coolant system comprises measuring rates of change of fluid pressure in response to applied gas pressure for different temperatures of fluid in the closed coolant system during operation of the closed coolant system.

9. The method of claim 1, wherein applying the gas pressure to the closed coolant system comprises applying pressure to a pressure equalizer fluidly coupled to the closed coolant system.

10. The method of claim 9, wherein the pressure equalizer comprises a tank including a fluid chamber, a gas chamber and a movable surface between the fluid chamber and the gas chamber that transmits pressure between the fluid chamber and the gas chamber.

11. The method of claim 10, wherein the movable surface comprises a flexible membrane.

12. The method of claim 10, wherein the movable surface comprises a piston.

13. The method of claim 1, wherein the closed coolant system comprises a coolant system for a fuel cell, and wherein applying the gas pressure to the closed coolant system comprises generating gas pressure in the fuel cell and applying the generated gas pressure to the closed coolant system.

14. A closed coolant system, comprising:
a coolant line;
a fluid pressure sensor coupled to the coolant line that detects a level of fluid pressure in the coolant line;
a pressure equalizer including an input port that receives applied gas pressure from a pressure source and an output port that applies pressure to the coolant line in response to the applied gas pressure;
a gas pressure sensor that detects a level of the applied gas pressure; and
a gas level monitoring system that detects a change of fluid pressure in the coolant line in response to the applied gas pressure, and determines a level of gas in the coolant line based on the change of fluid pressure in the coolant line in response to the applied gas pressure.

15. The closed coolant system of claim 14, wherein the pressure source comprises a turbine or compressor coupled to the pressure equalizer.

16. The closed coolant system of claim 14, wherein the pressure equalizer comprises a tank including a fluid chamber, a gas chamber and a movable surface between the fluid chamber and the gas chamber that transmits pressure between the fluid chamber and the gas chamber.

17. The closed coolant system of claim 16, wherein the movable surface comprises a flexible membrane.

18. The closed coolant system of claim 16, wherein the movable surface comprises a piston.

19. The closed coolant system of claim 14, wherein the closed coolant system comprises a coolant system for a fuel cell that generates the gas pressure.

20. A gas level monitoring system for monitoring a closed coolant system including a coolant line and a pressure equalizer including an input port that receives applied gas pressure from a pressure source and an output port that applies pressure to the coolant line in response to the applied gas pressure, a fluid pressure sensor coupled to the coolant line that detects a level of fluid pressure in the coolant line, and a gas pressure sensor that detects a level of the applied gas pressure, the gas level monitoring system comprising:
a sensor interface for receiving gas pressure measurement results from the gas pressure sensor and fluid pressure measurement results from the fluid pressure sensor; and
a processor coupled to the sensor interface that receives the gas pressure measurement results and the fluid pressure measurement results, detects a change of fluid pressure in the coolant line in response to the applied gas pressure based on the gas pressure measurement results and the fluid pressure measurement results, and determines a level of gas in the coolant line based on the change of fluid pressure in the coolant line in response to the applied gas pressure.
